(19) United States
(12) Patent Application Publication
(10) Pub. No.: US 2017/0305768 A1
(43) Pub. Date: Oct. 26, 2017

(54) WATER INTEGRITY AND APPARATUS FOR MEASURING HYDROGEN PEROXIDE IN WATER TREATMENT AND DISTRIBUTION SYSTEMS

(71) Applicant: SANECOTEC LTD., Ottawa (CA)

(72) Inventors: James SHUBAT, Ottawa (CA); Gerben OP DEN BUIJS, Veldhoven (NL); Ludo FEYEN, Heusden-Zolder (BE)

(73) Assignee: SANECOTEC LTD., Ottawa, ON (CA)

(21) Appl. No.: 15/100,634

(22) PCT Filed: Jun. 13, 2014
(86) PCT No.: PCT/CA2014/000503

§ 371 Date: Jan. 20, 2017

Related U.S. Application Data
(63) Continuation of application No. 14/094,754, filed on Dec. 2, 2013.
Application No. 14/094,754 is a continuation of application No. 14/292,593, filed on May 30, 2014.
(60) Provisional application No. 62/001,204, filed on May 21, 2014.

(30) Foreign Application Priority Data
Nov. 29, 2013 (CA) 2835012

(51) Int. Cl. C02F 1/72; C02F 1/00

(52) U.S. Cl. CPC C02F 1/722; C02F 1/008; C02F 2209/003; C02F 2307/14; C02F 2303/04

(57) ABSTRACT

As a measure of water integrity in water treatment and distribution systems, stabilized hydrogen peroxide is used as the secondary disinfectant. The concentration of hydrogen peroxide is monitored throughout the system and, if needed, additional hydrogen peroxide is injected into the system to maintain the level at established standard. An apparatus and method for measuring hydrogen peroxide concentration in water to an accuracy of 0.1 mg/L within water treatment and distribution systems comprises a colorimetric assay method to determine hydrogen peroxide concentration. The assay is monitored spectophotometrically at a desired wavelength. Each sample is corrected relative to a control sample and hydrogen peroxide concentration determined with respect to a standard curve.

### FIELD OF INVENTION

The present invention relates to water treatment and distribution systems. More particularly, the invention relates to maintaining water integrity in water treatment and distribution systems with stabilized hydrogen peroxide solutions as the secondary disinfectant. The water treatment and distribution systems further comprise an apparatus and method for measuring hydrogen peroxide to an accuracy of at least 0.1 mg/L in water, particularly in drinking water.

### BACKGROUND

Stabilized hydrogen peroxide solutions used for water disinfection, such as HUWA-SAN™ owned by Roam Chemie NV of Houthalen, Belgium, and SANOSIL™ owned by Sanosil Ltd. of Hombrechtikon, Switzerland are known in the art. Such hydrogen peroxide (H₂O₂) solutions are proprietary and are stabilized by silver ions or silver colloid in minute concentrations. Other stabilized hydrogen peroxide solutions are stabilized by alcohols, acids or other compounds. Depending on the solution, the stabilizer prevents the hydrogen peroxide from oxidizing too quickly when it contacts water, thereby allowing the solution to mix with the water before binding to and disinfecting undesirable microorganisms and chemicals.

Primary disinfection in water treatment systems has the objective of applying at or shortly after the source a disinfectant to destroy or inactivate pathogenic organisms in untreated water. Secondary disinfectant has the objective of applying to treated water, that is water which is already treated by a primary disinfectant, another disinfectant to preserve the integrity of the water in the distribution system.

One accepted disinfectant in secondary disinfectant is the maintenance of chlorine residual in the distribution system. This may be free chlorine (stronger) or chloramines (weaker), both of which have disadvantages. Chlorine drawbacks include the production of disinfectant by-products such as trihalomethanes (THMs) and haloacetic acids, chlorite and bromate. Chloramines are weaker oxidants than chlorine, resulting in fewer regulated by-products, however their use indirectly results in increased corrosion of lead and copper in the pipe system. It is also known that the effectiveness of chlorine as a disinfectant diminishes with an increase in the water's pH and a decrease in temperature.

Various apparatuses exist to measure the concentration of hydrogen peroxide in water including with chemiluminescent, fluorometric, amperometric and colorimetric sensors. The prior art sensors and detection systems were built to measure hydrogen peroxide concentration thresholds in swimming pool water treatment systems where regulations allow maximum levels not to exceed, for example, 150 mg/L (150 ppm), and typical operating concentrations are between 50-100 ppm. Other regulated uses have an established standard in the same order of magnitude.

In drinking water regulation, however, the acceptable concentration thresholds are much lower, often in the order of under 10 ppm. For example, in Ontario, Canada, an established standard concentration for drinking water is between 2-8 ppm. Existing detection methods are inadequate to quickly measure the concentration of hydrogen peroxide in water at such low levels at an accuracy of at least 0.1 ppm.

Alternatives to chlorine products are needed as secondary disinfectants in order to maintain water integrity in treatment and distribution systems, regardless of pH and temperature fluctuations, and without resulting in undesirable by-products. There is a need for a measurement apparatus and method to quickly detect low concentrations of hydrogen peroxide in water treatment and distribution systems, including for drinking water, in the order of 10.0 ppm or less and to an accuracy of at least 0.1 ppm. Such techniques must not be affected by pH, temperature or water composition.

### SUMMARY OF THE INVENTION

A water treatment system is disclosed which comprises a primary disinfectant apparatus for disinfecting source water. Downstream, a first dosing apparatus inject stabilized hydrogen peroxide into the system. A first monitoring apparatus measures the concentration of hydrogen peroxide residual to ensure it is within established parameters. One or more further monitoring apparatus measure the concentration of hydrogen peroxide residual downstream of the first monitoring apparatus. One or more further dosing apparatus are located proximate the one or more further monitoring apparatus. Each further dosing apparatus is configured to inject stabilized hydrogen peroxide into the system the measured level is not within established parameters. A network of pipes connects the source water to the primary disinfectant apparatus, the primary disinfectant apparatus to the first dosing apparatus, the first dosing apparatus to the first monitoring apparatus, the first monitoring apparatus to the one or more further monitoring apparatus and the one or more further monitoring apparatus to the one or more further dosing apparatus. The monitoring apparatus is capable of measuring hydrogen peroxide concentration to an accuracy of 0.1 mg/L.

In one embodiment, the first monitoring apparatus and the one or more further monitoring apparatus measure the residual and transmit measured residual data to a control system. The first dosing apparatus and the one or more further dosing apparatus receive signals from the control system to dose stabilized hydrogen peroxide, if needed.

In another embodiment, the control system monitors changes in measured residual data from two or more monitoring apparatus and compares the change to an established standard. The control system transmits signals to dose an established amount of stabilized hydrogen peroxide to the one or more further dosing apparatus if a measured residual data has reached an established threshold.

In a further embodiment the one or more further monitoring apparatus is located at a first or subsequent connection in the distribution system and at least one of the one or more further dosing apparatus is located at a first or subsequent connection in the distribution system.

In addition, a method of maintaining water integrity in a water treatment system is disclosed, comprising the steps of: disinfecting source water with a primary disinfectant, injecting stabilized hydrogen peroxide to the water, making a first measurement of the residual stabilized hydrogen peroxide in the water accurate to 0.1 mg/L, then downstream, making a second measurement of the residual stabilized hydrogen peroxide in the water accurate to 0.1 mg/L, and making a first determination whether the difference in the first and second measurements is within the established standard. The method further comprises injecting further stabilized hydrogen peroxide in the water if the difference in the first and second measurements is not within the established standard. In some embodiments, an alert is generated if the difference is not within the established standard.

In other embodiments, the method further comprises downstream, making one or more subsequent measurements of the residual stabilized hydrogen peroxide in the water accurate to 0.1 mg/L and making a further determination whether the difference in two preceding measurements is within the established standards. The method further comprises injecting further stabilized hydrogen peroxide in the water if the difference in the two preceding measurements is not within the established standard.

In a further aspect of the invention, an apparatus for measuring hydrogen peroxide levels in water using a colorimetric assay method is provided. The apparatus comprises a measurement cell for containing a water sample; a light transmitter configured to emit light at a selected wavelength at the measurement cell; a photodiode receiver configured to receive light passing through the measurement cell and a reagent in a reagent vial. The reagent comprises a reagent compound configured to react with hydrogen peroxide to form a reaction product, the reaction product is adapted to absorb light at the selected wavelength proportional to the amount of hydrogen peroxide in the water sample. The apparatus also comprises a surfactant and a solvent. Within the apparatus, there is a first network of pipes connecting source water to a buffer jar, the buffer jar to a supply valve, the supply valve to the apparatus measurement cell, and a second network of pipes connecting the reagent vial to a reagent valve, the reagent valve to the measurement cell, and the measurement cell to a drain valve; and a control unit; the control unit is configured to cause a first colorimetric measurement of a first water sample free of reagent and a second colorimetric measurement of a second water sample mixed with reagent. The control unit determines the difference between the first and second measurements and compares the difference against a pre-determined standard curve of diluted hydrogen peroxide to determine and report the concentration of hydrogen peroxide in the water sample, accurate to 0.1 mg/L.

In one embodiment the reagent compound is potassium bis (oxalato) oxotitanate (IV) DI. The selected wavelength is 470 nm. The light transmitter is a LED light emitter. The reagent further comprises EDTA di-sodium salt dehydrate. The surfactant is polyoxyethylene (23) lauryl ether and the solvent is sulfuric acid 99%: p.a. 10% solution.

In a further embodiment the predetermined standard curve comprises data points from 0 ppm to 150 ppm.

In another embodiment the predetermined standard curve comprises data points from 0 ppm to 100 ppm.

In another aspect of the invention, there is provided a method of measuring hydrogen peroxide levels in water using a colorimetric assay comprising transferring a first water sample to a measuring cell; determining a first absorbance measurement of light at a selected wavelength as a null measurement; removing the first sample from the measurement cell; transferring an aliquot of a reagent consisting of a reagent compound configured to react with hydrogen peroxide to form a reaction product, the reaction product adapted to absorb light at the selected wavelength proportional to the amount of hydrogen peroxide in the water sample to the measurement cell; filling the measurement cell with a second water sample; determining a second absorbance measurement of light at the selected wavelength as a test measurement; emptying the measurement cell and rinsing with sample water; and a control unit adapted to determine the difference between the first and second measurements and compare the difference against a pre-determined standard curve of diluted hydrogen peroxide to determine and report the concentration of hydrogen peroxide in the water sample to an accuracy of 0.1 mg/L.

In another embodiment the method uses the reagent compound is potassium bis (oxalato) oxotitanate (IV) DI. The selected wavelength is 470 nm. The light transmitter is a LED light emitter. The reagent further comprises EDTA di-sodium salt dehydrate. The surfactant is polyoxyethylene (23) lauryl ether and the solvent is sulfuric acid 99%: p.a. 10% solution. A further embodiment of the method relates to the selected wavelength is 470 nm.

In one embodiment the predetermined standard curve of the method comprises data points from 0 ppm to 150 ppm.

In a further embodiment the predetermined standard curve of the method comprises data points from 0 ppm to 100 ppm.

### BRIEF DESCRIPTION OF THE DRAWINGS

Embodiments are illustrated by way of example and not limitation in the following figures, in which like references indicate similar elements.

FIG. 1 is a schematic of a prior art water treatment system which uses chlorine in the form of sodium hypochlorite as a secondary disinfectant;

FIG. 2 is a schematic of one embodiment of the water treatment system of the present invention which uses stabilized hydrogen peroxide as the secondary disinfectant;

FIG. 3 is a process showing how the apparatus in the system communicates with the control system;

FIG. 4 is a box diagram of one embodiment of an apparatus of the present invention;

FIG. 5 is a diagram of one embodiment of FIG. 4 showing the analysis unit and control unit;

FIG. 6 is a close-up diagram of FIG. 5 including an expanded portion illustrating the buffer jar;

FIG. 7 is a schematic of a close-up of the apparatus of FIG. 5 showing the buffer jar, reagent vial and measurement cell;

FIG. 8 is a schematic of a close-up of the apparatus of FIG. 5 showing the direction of flow and measurement cell;

FIG. 9 is a schematic of a close-up of the apparatus of FIG. 5 showing the measuring cell, LED and receiver;

FIG. 10 is a chart of measured hydrogen peroxide concentration used to calibrate one embodiment of the apparatus of the present invention;

FIG. 11 is a logarithmic chart of hydrogen peroxide values generated to calibrate one embodiment of the apparatus of the present invention;

FIG. 12 is a pre-determined standard curve generated by plotting absorbance data relative to concentration of hydrogen peroxide for use in determining the concentration of hydrogen peroxide in a measured test sample, in accordance with one embodiment of the present invention; and

FIG. 13 is a pre-determined standard curve generated by plotting digitized measurement data relative to concentration of hydrogen peroxide for use in determining the concentration of hydrogen peroxide in a measured test sample in accordance with one embodiment of the present invention.

### DETAILED DESCRIPTION

Example embodiments, as described below, may be used to provide a water treatment and distribution system using stabilized hydrogen peroxide (SHP) as a secondary disinfectant, and may be used to provide an apparatus and method to quickly measure hydrogen peroxide residual in water at very low concentrations.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In the case of conflict, the present specification, including definitions, will control. In addition, the materials, methods, and examples are illustrative only and not intended to be limiting.

A stabilized hydrogen peroxide residual refers to a level of SHP remaining in the water after treatment. An effective residual level of SHP refers to a range of concentration within a determined range wherein antimicrobial effects are achieved and is within a range suitable and approved for human consumption (i.e. 1-8 ppm).

An acceptable SHP has the capacity to demonstrate the following; a level of antimicrobial activity, equivalent to or better than conventional disinfectants such as chlorine; have antimicrobial and oxidative activity at a wide pH range (i.e. pH 2-pH 9); is stable and maintains a residual level in hot or cold water (as commonly found in a residential water system) for a prolonged period of time (i.e. 5-10 days); meets governmental requirements for use in drinking water (i.e. food grade or NSF 60 approval); has no harmful degradation products; and shows inhibition properties against biofilm formation.

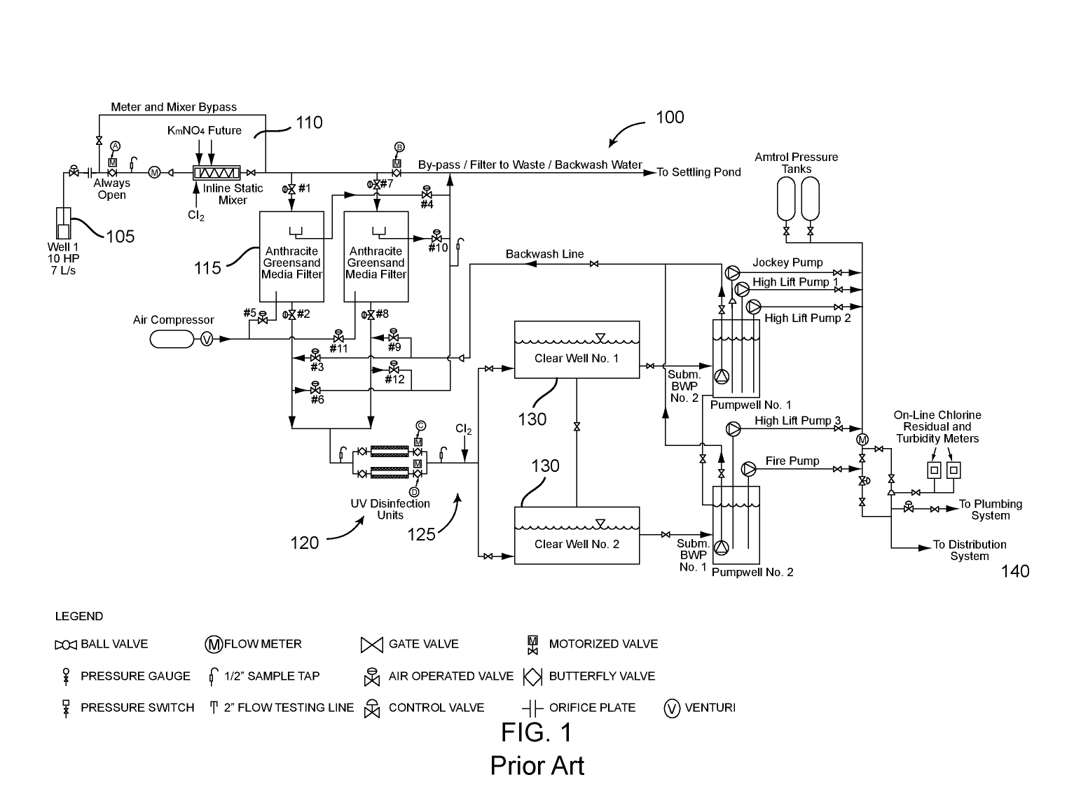

FIG. 1 shows a schematic prior art municipal water treatment system 100. Well water 105 undergoes pre-treatment with KMnNO₄ and sodium hypochlorite 110 in order to oxidize the dissolved iron and manganese, followed by exposure to anthracite greensand media contactors 115 for iron and manganese removal. The pre-treated water is then disinfected using ultra-violet (UV) units 120 as the primary disinfectant. Treated water is then fed with sodium hypochlorite by a chlorine dosing apparatus 125 as the secondary disinfectant before being directed to an in-ground storage reservoir consisting of two clear wells 130 where the water remains for several days until is needed in distribution. Biofilms can be produced in the clear wells 130 which can be cause for disinfection by-product formation together with naturally occurring organics in the water. The water is eventually pumped, as needed, into the water distribution system 140. Every time the level of trihalomethanes exceeds the regulated standard, a health risk is present. The distribution system needs to be flushed and treated water is wasted.

THM levels measured after contactors 115 and before the clear wells 130 were below 15 μg/L. In the clear wells 130, the measured THM levels ranged from 104 to 112 μg/L. The results suggested that elimination of the secondary disinfectant (sodium hypochlorite) which entered clear wells 130 would be required to reduce the THM levels.

Stabilized hydrogen peroxide was found to be a suitable replacement as a secondary disinfectant as described herein. Unlike chlorine products, SHP solutions have effective disinfectant characteristics that are not influenced by expected changes in temperature or pH.

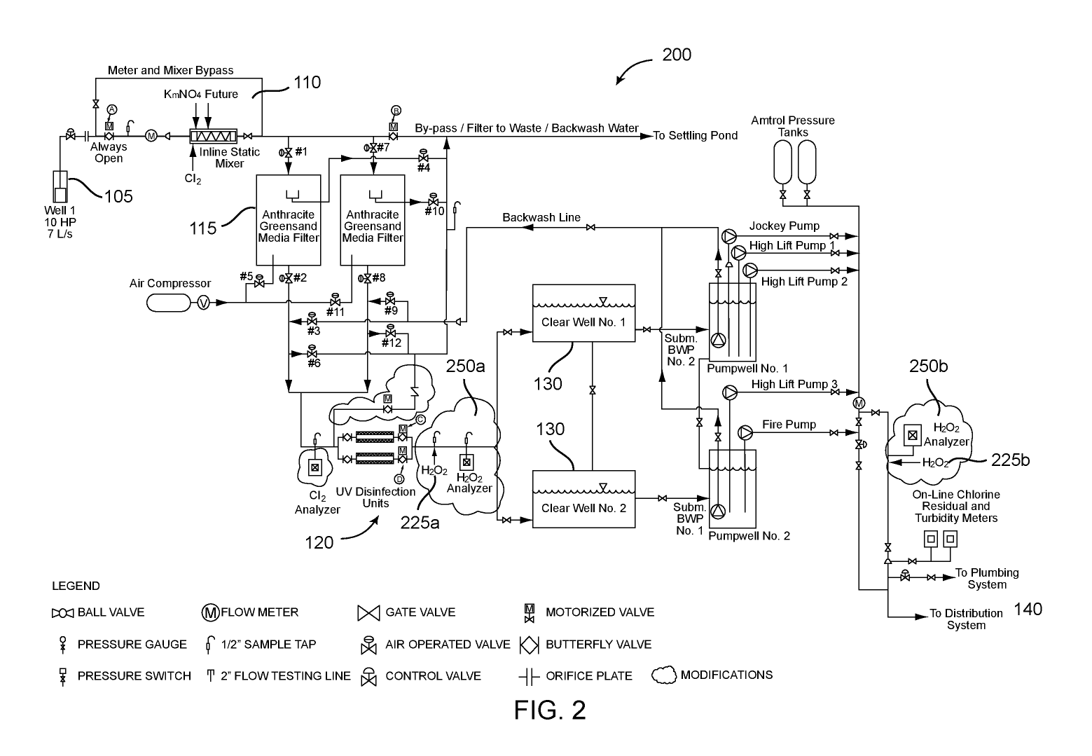

In one embodiment, as shown in FIG. 2, the municipal water treatment system 200 was modified to remove the chlorine dosing apparatus (125 from FIG. 1) and replaced with a first dosing apparatus 225a configured to provide an effective amount of SHP solution. The term dosing apparatus 225, as used herein, is understood to refer to any dosing apparatus in a non-specific manner. In one embodiment, HUWA-SAN (tm) 25% was used. Other SHP solutions are contemplated. Prior to entering the clear wells 130, water samples are drawn to measure the concentration of hydrogen peroxide residual with monitoring apparatus 250a. The treated and peroxygenated water enters the clear wells 130. After exiting the clear wells 130, the water is pumped, as needed, towards the distribution system 140. Prior to entering the distribution system 140, water samples are drawn to measure the concentration of hydrogen peroxide residual with monitoring apparatus 250b. The term monitoring apparatus 250, as used herein, is understood to refer to any monitoring apparatus in a non-specific manner. Water samples may be drawn, and the hydrogen peroxide residual determined, in a repetitive sequential manner at an interval to provide effective monitoring and confirmation of water integrity. Preferably sampling is done on a continuous basis.

In one embodiment a treatment system is modified with a first dosing apparatus to introduce an effective amount of SHP solution. A SHP may be supplied as HUWA-SAN™ or other SHP at a dosing rate to provide an effective amount in the water flow. A SHP may be supplied at a concentration that could range from 1% to 25% and introduced at a dosing rate such that the diluted SHP provides an effective amount in the water flow.

The measured level of hydrogen peroxide from monitoring apparatus 250a is compared with the measured level from monitoring apparatus 250b. The measured level monitoring apparatus 250b is expected to be the same or lower than the measured level in monitoring apparatus 250a, the change resulting from oxygenation (ie: disinfecting) which occurred between the two monitoring apparatus 250a, 250b.

If the measured level remains within an established standard of hydrogen peroxide for the given application, such as between 2-8 ppm (Ontario, Canada), the water is then transported to the distribution system. If however the measure level falls to the lower limit or below the lower limit, a second dosing apparatus 225b configured to provide SHP solution, injects an effective amount of SHP solution to the water in order to raise the concentration of hydrogen peroxide to within the established standard. Optionally, an alert may be generated, such as a sound, communication or flashing light to warn personnel of additional dosing.

In order to maintain SHP residual levels within the established standard, the control system may be configured with an established threshold that is of a narrower range than the established standard. Monitoring data reaching the established threshold elicits an action by the control system to regulate a SHP dosing apparatus such that the SHP residual remains within the established standard.

For example, if the level of hydrogen peroxide measured by monitoring apparatus 250a is 7 ppm and the level of hydrogen peroxide measured by monitoring apparatus 250b is 3 ppm, resulting in a 4 ppm delta, this suggests that a large amount of hydrogen peroxide has been oxidized in the system perhaps at the clear wells 130 or in the interconnecting piping. In this instance, since the measured amount by monitoring apparatus 250b is at or near the lower limit, second dosing apparatus 225b could be configured to automatically dose additional hydrogen peroxide to raise the concentration level to, for example 6 ppm prior to entering the distribution system.

In a similar manner, additional monitoring apparatus 250c, 250d, 250e, etc. may be placed in the distribution system to monitor the concentration of hydrogen peroxide at specific locations in the system, such as at junctions, pumps, water towers, neighbourhoods, commercial buildings, industrial buildings and residences. Preferably monitoring is done on a continuous basis. Additional locations may be where there is a concern about stagnant water or when additions or modifications are being made to the system's piping.

In larger distribution systems which are, for example several kilometers in length, additional dosing apparatus 225c, 225d, 225e, etc. may be placed downstream a respective monitoring apparatus 250c, 250d, 250e, etc. to inject hydrogen peroxide on an as needed basis so as to satisfy the standard and maintain water integrity. In a system which has not been compromised, the one or more dosing apparatus serves as an emergency station. In some embodiments, there are more monitoring apparatus and only a few dosing apparatus. In other embodiments, each monitoring apparatus is paired with a dosing apparatus. In still other embodiments, an apparatus may comprise both the monitoring and dosing functions.

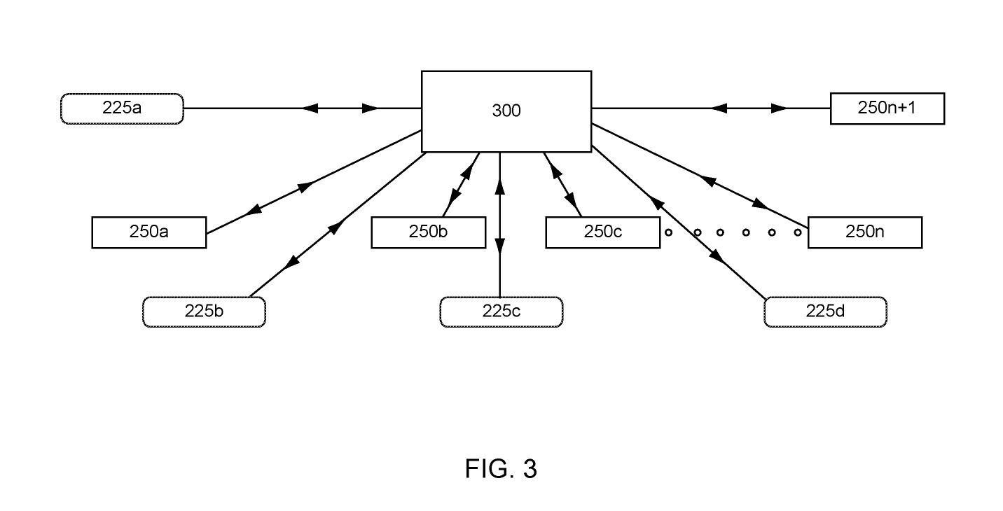

Each monitoring apparatus 250a, 250b, 250c, 250d, 250e, etc. and each dosing apparatus 225a, 225b, 225c, 225d, 225e, etc. are connected to the water treatment control system 300 either by wired or wireless connections so that data of measurements and dosing amounts are frequently, or preferably continuously, relayed to and/or from control system 300, as shown in FIG. 3. Upon receiving data from a monitoring apparatus which is indicative of a drop in residual hydrogen peroxide that may require dosing, the control system 300 transmits appropriate signals to the appropriate dosing apparatus to inject an effective amount of hydrogen peroxide into the system so as to raise the concentration of hydrogen peroxide in the system to an acceptable level.

If an unexpected delta in hydrogen peroxide residual between two adjacent monitoring apparatus 250n, 250n+1 were to be received by control system 300, appropriate alerts are sent to investigate or remedy the problem. Furthermore, trending data over time may reveal a gradual increase in deltas between any two given monitoring stations, which may signify the introduction of contaminants that are being oxidized.

One embodiment is a system comprising first monitoring apparatus 250a and first dosing apparatus 225a, both located before the clear wells; second monitoring apparatus 250b and second dosing apparatus 225b, both located before the beginning of the distribution system; and monitoring apparatus 250c located at the first connection in the distribution system, about 1.5 km away.

It is contemplated to add further monitoring apparatus at multiple connections in the distribution system. It is further contemplated to add further dosing apparatus at multiple connections in the distribution system. The monitoring and dosing functions may be part of one apparatus. Placement locations in the distribution system include at the connection for a residence, a building, a neighbourhood, a water tower, etc.

Preferably monitoring apparatus 250 are configured to provide continuous sampling and determination of hydrogen peroxide concentration, thereby providing optimal monitoring. Sampling and determination of hydrogen peroxide concentration at a periodic interval is contemplated.

Monitoring apparatus 250 of the water treatment and distribution system must provide a level of accuracy such that the integrity of the water is maintained and the system can control the SHP residual level within the approved range. For example, between 2-8 ppm for human consumption. Given the narrow range of acceptable SHP residual in water destined for human consumption, an accuracy of 0.1 ppm is preferred. In some applications an accuracy of at least 3 ppm may be acceptable.

Example 1 describes the use of SHP as a replacement to chlorine and chloramines as a secondary disinfectant, together with the continuous monitoring and dosing system. The SHP treatment provides a measure of water integrity in the water treatment and distribution system while reducing the level of disinfectant by-products including THMs.

While the invention has been described with respect to a water treatment system and distribution system for a community, it may equally be applied to other systems, including for industrial buildings, commercial buildings, hotels, multi-tenant residences, hospitals, agricultural applications, and the like.

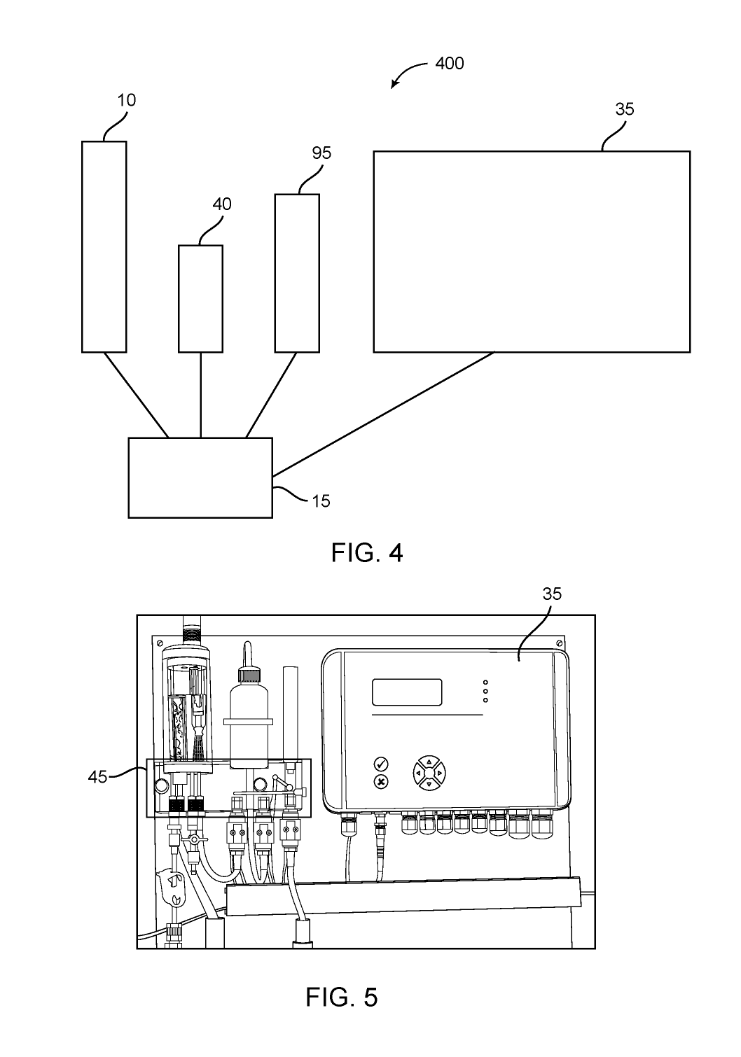

The monitoring apparatus 250 is configured to perform an assay to determine the concentration of hydrogen peroxide. This may include digitization of measurement data and use of a computer algorithm to calculate the hydrogen peroxide concentration to an accuracy of 0.1 ppm. The monitoring apparatus 250 may be a colorimetric monitoring apparatus 400 as shown in FIG. 4.

Use of hydrogen peroxide in water distribution systems require that the residual H₂O₂ concentrations be within an acceptable range (2-8 ppm) and determination of H₂O₂ concentrations must be sufficiently accurate to allow monitoring and control of the H₂O₂ in this range. Preferably the monitoring apparatus is accurate to about 0.1 ppm.

A colorimetric monitoring apparatus 400 of the present invention includes a colorimetric assay method to determine hydrogen peroxide concentration. A colorimetric method is based on production of a reaction product that absorbs light at a selected wavelength. Preferably a reagent compound used to produce the reaction product does not have significant light absorption properties at the selected wavelength. Formation of the reaction product is proportional to the amount of hydrogen peroxide in the water sample. Quantification of the reaction product is measured and converted to a H₂O₂ concentration based on a standard curve.

A preferred colorimetric method is based on production of a reaction product that produces a yellow to orange coloured complex when potassium bis(oxalato)-oxotitanate (IV) reacts with hydrogen peroxide to form a reaction product adapted to absorb light at 470 nm proportional to the amount of hydrogen peroxide in the sample. Quantification of the reaction product is measured at 470 nm and converted to a H₂O₂ concentration based on a calibration curve. The photodiode measurement data produced by the reaction product of the above reactant with H₂O₂ has been determined to correlate logarithmically with H₂O₂ concentration. Alternatively, other wavelengths may be used such as 400 nm. The wavelength that gives the maximum absorbance of a coloured reaction product is one consideration in choosing a selected wavelength. Additionally the resulting standard curve and degree of linearity that can be achieved may vary at each wavelength. In one embodiment of the present invention, the wavelength is selected to be 470 nm. The standard curve generated with this data produces a near linear standard curve and a high degree of accuracy is thereby achieved. Other wavelengths of light are contemplated.

One objective is to obtain the greatest accuracy by facilitating the closest possible adherence to the Lambert Beer principles of light absorption between the transmitter and receiver, in accordance with the formula:

$$\frac{{I}_{1}}{{I}_{0}} = {10}^{- E} = {10}^{- ecd}$$

In one embodiment, a colorimetric monitoring apparatus 400 is provided in FIG. 4. The main components of the apparatus 100 include control unit 35, measurement cell 15, buffer jar 10, reagent vial 40 and, to a lesser extent, riser tube 95.

Water flowing in a system, such as a water treatment and distribution system, comprises an unknown quantity of dosed SHP, which acts as a disinfectant. In one embodiment the dosed SHP is HUWA-SAN 25. The use of other stabilized hydrogen peroxides is contemplated at various concentrations.

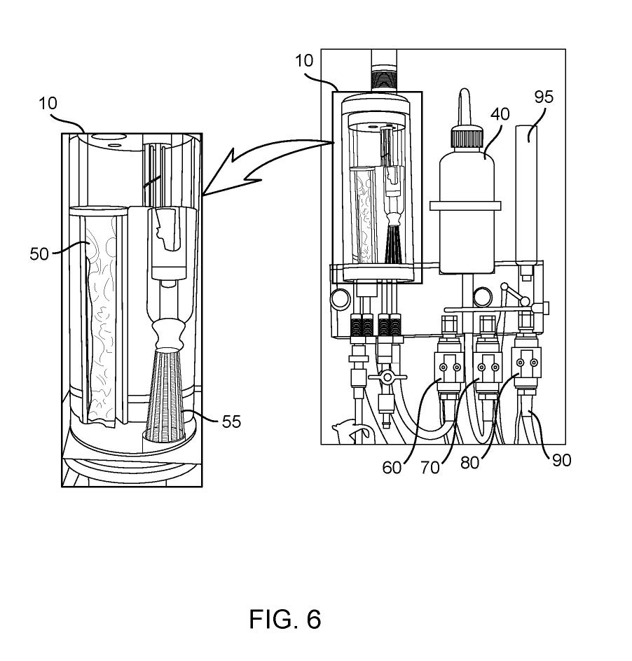

As shown in FIG. 5, there is provided apparatus 400 in accordance with one embodiment of the present invention. A close-up diagram of apparatus 400 is provided in FIG. 6, which includes a further close-up diagram of buffer jar 10. Apparatus 400 continuously receives water from the system and directs it into buffer jar 10. Buffer jar 10 serves as a reservoir from where a water sample can be directed to a measuring cell 15 at a desired time interval. An overflow tube 50 returns water to the system, thereby maintaining a constant volume in the buffer jar 10 and a turn-over of water in the buffer jar 10. Water exiting buffer jar 10 may first pass through a filter 55 to remove particulate matter. Optionally the filter 55 may be installed prior to water entering buffer jar 10 or in such other locations as to prevent or limit particulate matter from entering colorimetric monitoring apparatus 400. Sample water flow is directed from the buffer jar 10 to the measurement cell under control of a supply valve 60, reagent is directed to the measurement cell under control of a reagent valve 70, and a drain valve 80 operates to control fluid retention in, or draining of, the measurement cell 15. Outflow from the measurement cell 15 is directed to a waste drain 90. The measurement cell 15 has an upper opening and a lower opening 85. The lower opening is connected to a network of piping to allow filling and emptying of the measurement cell 15 with sample water and reagent as required. The upper opening is connected to a riser tube 95. The riser tube 95 extends upward to at least the height of the water level in the buffer jar 10. The riser tube 95 increases the efficiency of rinsing the measurement cell 15 by providing added volume and force of the water movement. Plumbing connects the elements to provide a conduit for fluid flow. For example, a first network of pipes connecting the source water to the buffer jar 10, the buffer jar 10 to the supply valve 60, the supply valve 60 to the measurement cell 15, and a second network of pipes connecting the reagent vial 40 to the reagent valve 70, the reagent valve 70 to the measurement cell 15, the measurement cell 15 to the drain valve 80, and the drain valve 80 to the waste drain 90. Such plumbing can be composed of PVC piping, or flexible tubing such as Tygon™ tubing, a combination thereof, or other such conduit as desired.

The direction of flow of the various fluids is depicted in FIG. 8, showing (by arrows) the supply sample fluid flow through supply valve 60, the supply reagent fluid flow from reagent valve 70 and the cell drainage from measurement cell 15 through drain valve 80.

In one embodiment, a colorimetric apparatus 400 is provided that receives water from a system into a buffer jar 10, draws a first water sample from the buffer jar into a measurement cell 15 to determine a null or background reference measurement, removes the first sample, draws an aliquot of reagent from a reagent vial 40 into the measurement cell 15 and draws a second water sample from the buffer jar 10 into the measurement cell 15 to determine a sample measurement. The null measurement is subtracted from the sample measurement and the difference value is interpreted relative to a standard curve for a determination of hydrogen peroxide concentration. A standard curve can be represented graphically or by mathematical expression of the curve. The mathematical expression is useful in a digital system.

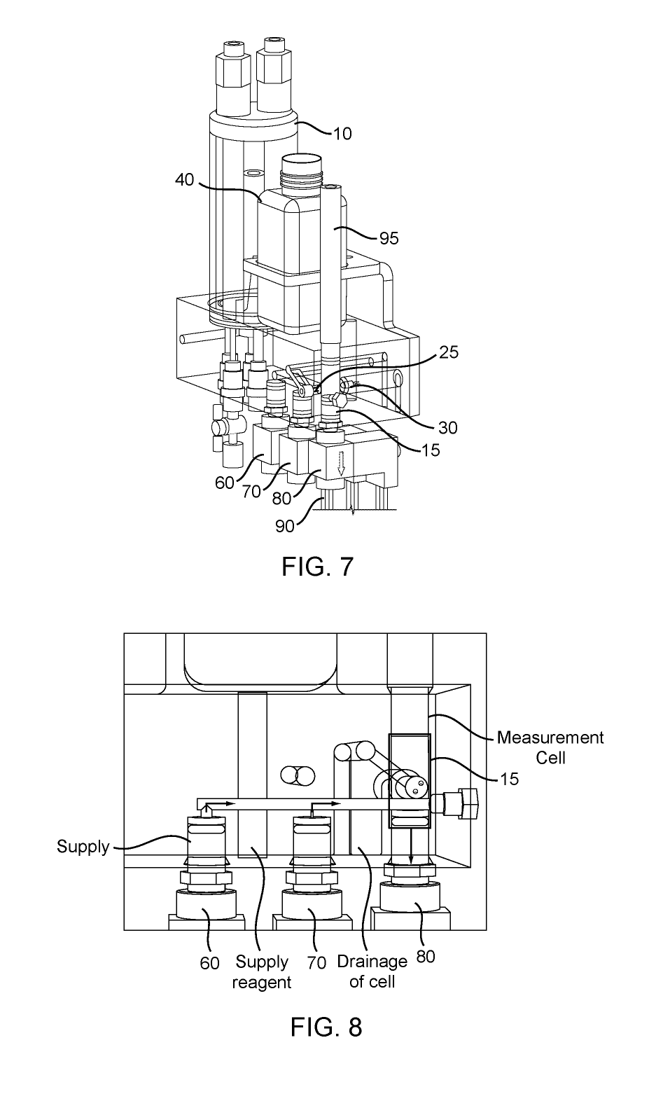

A side perspective view of FIG. 6 is provided in FIG. 7, showing light emitter 25 and light receiver 30 on either side of measurement cell 15. The size and design of the measurement cell 15 will influence the accuracy and efficiency of the measurement.

Factors may include, but are not limited to, the path length from a light emitter 25 to a light receiver 30, the light yield of the light source and the sensitivity of the light receiver 30, the measurement cell 15 composition and cell wall thickness, and distance between emitter 25 and light receiver 30 elements. The physical parameters such as measurement cell wall thickness, path length and light emitter and receiver equipment are fixed once chosen and therefore can be compensated by hardware calibration and system settings. In a preferred embodiment, measurement cell 15 was custom milled from a single piece of thermoplastic polycarbonate, such as Lexan™, with known techniques such as a CNC mill station.

In one embodiment, the measurement cell 15 has a width of 10 mm; cell wall thickness of 1 mm, and cell height is 19.5 mm. A measurement cell of these dimensions produces a sample volume of about 2 mL. Other volumes are contemplated. These parameters were selected as optimal dimensions for this embodiment given a number of factors including sufficient sample size for greatest accuracy and precision, as well as cost. The material used for the measurement cell was chosen based on light transmission capabilities and resistance to degradation from water and chemical reagents. All channels were polished to a high transparency level to maximize light transmission. Measurement cell 15 was polished on the inside to enable maximum light transmission.

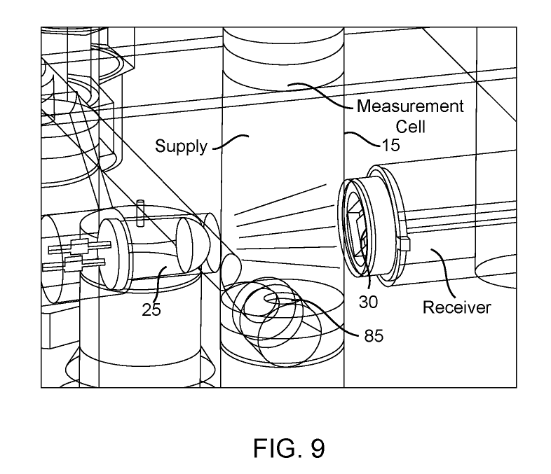

The measurement chamber shown in FIG. 9 comprises a light source 25 to emit light at a selected wavelength, measurement cell 15, and a light receiver 30. The light receiver 30 may be a photodiode light receiver 30. Preferably the light emitter 25 is a LED light which emits light at 470 nm. The light is transmitted through the walls of the measurement cell 15 containing the sample and the resulting non-absorbed light is captured on photodiode 30. A small current is generated in the photodiode 30, which is measured by an operational amplifier on the colorimetric apparatus 400 and converted by an analog/digital (AD) convertor to an internal value of 1000, which is the resolution of the measurement processor. This is the null value or zero reagent sample.

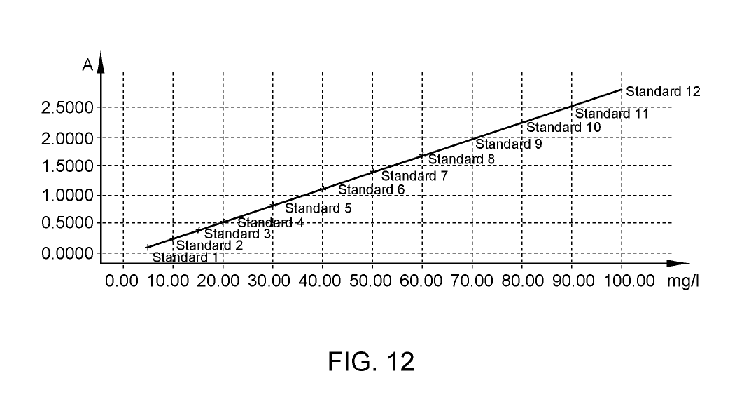

FIG. 12 shows a plot of absorption over concentration (mg/L) and establishes that the light absorption of the reaction product is linear in relation to the concentration of hydrogen peroxide. The raw data produced by the photodiode 30 and that of the Analogue-Digital (AD) convertor results in a logarithmic relationship to H₂O₂ concentration. With respect to units used to express concentration of H₂O₂ both mg/L and ppm are commonly used. It is noted that 1 mg/L is equivalent to 1 ppm.

A reagent mixture was developed wherein a substrate reagent reacts with H₂O₂ to produce a reaction product in a stoichiometric relationship. The reaction product is detected spectrophotometrically at a selected wavelength and correlated to sample hydrogen peroxide concentration. Components of the reagent mixture do not interfere with the colorimetric measurement and are not effected by variable water characteristics such as water hardness or trace metal or organic components. An effective amount of a surfactant is optionally added to improve reagent mixture flow characteristics through the measurement cells and interconnecting channels.

In one embodiment, the reagent mixture comprises the following compounds: potassium bis (oxalato) oxotitanate (IV) DI (Merck KGaA, Darmstadt, Germany); EDTA di-sodium salt dihydrate Titriplex III™ (Merck KGaA, Darmstadt, Germany); Surfactant: Polyoxyethylene (23) lauryl ether Brij™ 35 (30%) (Sigma-Aldrich); disolved in a solvent of sulfuric acid 99%: p.a. 10% solution (Merck KGaA, Darmstadt, Germany).

The reagent mixture is prepared as follows for a 1,000 mL final volume, 50 g potassium bis (oxalato) oxotitanate (substrate reagent), 0.2 g EDTA di-sodium salt dehydrate, sulfuric acid 99% to a final dilution of 10%, and lml of polyoxyethylene (23) lauryl ether.

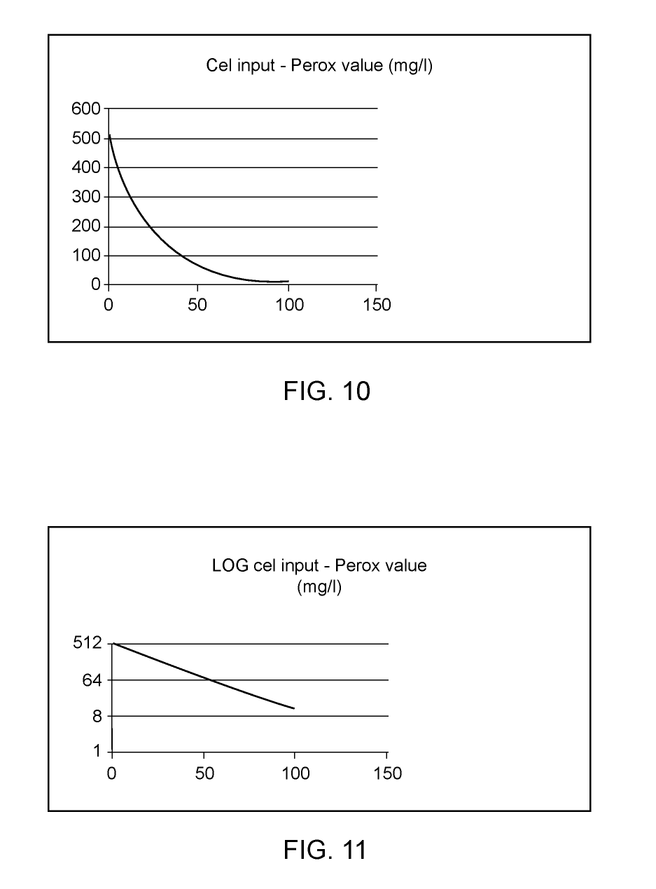

Prior to use, the colorimetric apparatus 400 is calibrated. Samples having known concentrations of hydrogen peroxide are measured and a standard curve is created by plotting the observed measurement cell output signal measurement against the known concentration. This curve can be represented graphically (see FIG. 10) or by mathematical extrapolation. The concentration of hydrogen peroxide in an unknown sample is then determined with reference to the standard curve and the result reported, displayed or recorded either digitally, graphically or by other convenient means. Preferably, the standard curve includes a range of known samples spanning the range of concentrations to be measured, for example from 0-150 mg/L (ppm). The standard curve comprising data points in the desired range (i.e. 0-150 mg/L) greatly increases the accuracy of the determination and is key to providing an accuracy of 0.1 mg/L.

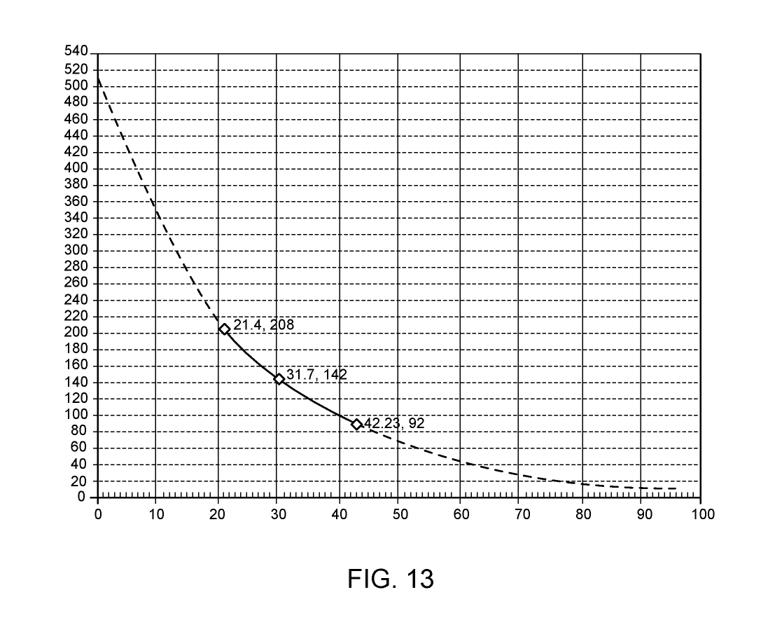

A known concentration of hydrogen peroxide is required in order to calibrate the apparatus. Perhydrol™ 30% for analysis EMSURE™ ACS, ISO from EMD Millipore Corporation of the Merck Group, was used. Other certified trade solutions can also be used so long as the accuracy is in the order of 99.999%. Standard solutions for spectrophotometric measurement are made between 0 to 100 mg/L which is the measurement range of the apparatus of the present invention. The concentrations of the Perhydrol dilutions are confirmed and validated through a standard titration method, for example iodometry. Subsequently a pre-determined number of measurements are carried out in the apparatus with these known concentrations and raw data (see Table 1) is generated to create a standard curve, as shown in FIG. 13.

TABLE 1

| mg/L | Raw Value | Raw Value With Correction (*511/480) |
|---|---|---|
| 0 | 480 | 511 |
| 5 | 384 | 409 |
| 10 | 309 | 329 |
| 15 | 245 | 261 |
| 20 | 201 | 214 |
| 30 | 134 | 143 |
| 40 | 93 | 99 |
| 50 | 60 | 64 |
| 60 | 42 | 45 |
| 70 | 31 | 33 |
| 80 | 24 | 26 |
| 90 | 20 | 21 |
| 100 | 12 | 13 |

The standard curve is used to calibrate colorimetric apparatus 400. The value of raw value in Table 1 is the raw data of the measured sample at a scale of 0-480 as determined by the photodiode 30. A value of 480 represents 0% absorbance (100% transmission) and represents a zero or null sample reflecting that there is no hydrogen peroxide in the sample. The resolution of the Analogue-Digital (AD) convertor is 512 bit (0-511). Raw values are converted to digital values by multiplying by 511 and dividing by 480, a factor of 1.0646. The measured value is compensated for full scale. The standard curve is determined with the apparatus in one embodiment of the present invention, which measures in 10 bit resolution (1000 steps, 100 ppm/1,000=0.1 ppm resolution).

A standard curve is generated by using a number of data points. The standard curve becomes more accurate when more points are generated. Preferably, data points are biased in the lower range of detection, for example 0-20 ppm and cover the entire range of desired detection, for example 0-150 ppm. Once generated the standard curve can be represented mathematically for convenient use within an algorithm of the control unit 35. Example 3 describes a standard curve and the mathematical derivation of a H₂O₂ concentration based on the curve.

Calibration of the colorimetric apparatus 400 to control for hardware variables is performed for each measurement cell. Hardware variables include wall thickness of measurement cell, specific path length between light emitter 25 and photodiode light receiver 30, and the light yield of the light emitter 25 and the sensitivity of the photodiode light receiver 30. Prior to use a calibration adjustment to compensate for hardware variables is performed. The measurement cell 15 is filled with distilled water and the measurement signal that originates from the photodiode 30 is then measured through an input potentiometer and adjusted to 1,000. This is the resolution of the measurement processor within the control unit 35. When replacing the measurement cell 15, adjustment to the photodiode 30 or LED 25 recalibration is essential.

A pre-measurement software adjustment to the photodiode light receiver 30 sets the photodiode 30 to a value of 1,000 based on a control water sample present in the measurement cell 15. A test water sample containing added reagent produces the colored complex and absorbs more light in logarithmic dependence to the amount of hydrogen peroxide in the sample (see FIG. 11). Consequently, the light that is not absorbed reaches photodiode receiver 30, resulting in a relatively smaller current in comparison with the reagent-free sample measurement. A measurement of the test sample containing hydrogen peroxide will be lower than 1,000. The colorimetric apparatus 400 measures the change in current. By adjusting for the measurement in the reagent-free sample, any absorbance due to water turbidity or composition of the water sample and chamber walls is accounted for.

To achieve maximum accuracy and sensitivity during operation the colorimetric apparatus 400 will run a control sample (test water alone) as a reference point, a sample measurement is then made with sample water plus reagent. By factoring in the control sample at each test sample, variability in water composition and turbidity are controlled for and accuracy of the hydrogen peroxide concentration determination maximized. Preferably, an accuracy to 0.1 ppm is achieved.

In making a measurement, an aliquot of reagent is transferred from the reagent vial 40, and a water sample is transferred from buffer jar 10, into the measuring cell 15. The aliquot of reagent is kept small, however an excess of reagent compound can be provided such that in the measuring cell 15, hydrogen peroxide is the limiting reactant in the assay mixture. For a reagent mixture prepared as described above and a 1.5 mL sample volume, the volume of required reagent was 0.03 mL in one embodiment. This is suitable to provide accurate detection of hydrogen peroxide to a maximum water sample concentration of 100 ppm.

It is noted that the volumes of sample and reagent are measured precisely and consistently in order to achieve precise measurements. As such, a control unit 35 comprising a software algorithm is used to provide precise control of the valves in order to deliver the optimal amount of reagent to ensure accuracy. The valves are controlled by the control unit 35 in a time-dependent manner. A valve time refers to the length of time the valve is in the open position thereby allowing fluid flow. The valve time is correlated to a volume such that a known valve time will result in the movement of a known volume. These times may vary depending on the specific characteristics of the valve in use and are readily determined. In one embodiment, the reagent valve time has been set to 30 milliseconds to allow a reagent volume of 0.03 mL to pass the valve. Head pressure in the water or reagent system may affect the volume of fluid that passes the valve during a given valve time. Compensation may be made in a variety of means. For example, the buffer jar 10 maintains a constant volume and therefore maintains a constant head pressure, a similar reagent buffer jar may readily be incorporated into the system design. Alternatively, other designs may be incorporated to provide consistent pressures such as the use of a pressurized head space over the liquid. The control unit 35 is programmed to provide the desired valve time at each step of the measurement cycle. For example valve times for flushing and rinsing of measurement cell are different than the valve time to add the volume for a test water sample. Other valve times are contemplated.

In one embodiment, the control unit 35 operates to measure hydrogen peroxide concentration in a water system by diverting samples to colorimetric apparatus 400 on a periodic basis, such as every 2 minutes. Other time intervals are contemplated. The steps comprise:
Measurement cell 15 is filled with sample water;
Measurement cell 15 is emptied, flushing measurement cell 15 to keep it clean;
Measurement cell 15 is refilled with sample water;
Measurement is obtained and set as a zero measurement (null value);
Measurement cell 15 is emptied;
Measurement cell 15 receives an aliquot of reagent from reagent vial 40, and measurement cell 15 is filled with sample water;
Measurement is obtained as test measurement;
Empty measurement cell 15;
Fill and empty measurement cell 15 with sample water to rinse cell;
Fill and keep measurement cell 15 full until the next measurement is initiated.

The control unit 35 includes analysis capability and determines the test sample hydrogen peroxide concentration by an algorithm that comprises the steps of: calculating the difference between null and test sample measurements; determining the concentration of hydrogen peroxide from a standard curve; reporting and/or recording the sample hydrogen peroxide concentration.

In a further embodiment, the valve time (the time the reagent valve is open) is variable and the control system calculates the required volume of reagent. The objective is to optimize reagent use. The control system calculates the average H₂O₂ concentration of at least the two previous samples and bases its next valve time on an expected H₂O₂ concentration. A limitation of this method results in inaccuracies when the hydrogen peroxide level fluctuates quickly, as the reagent dosing calculation lags the actual reagent requirement.

In an alternative embodiment, the control system is set to control valve time, and thus reagent volume, based on multiple measurements of each test sample. The results are used by the control system to adjust reagent volume as required. In one embodiment for a measurement of hydrogen peroxide in a test sample an aliquot of reagent is introduced into the measurement cell, the measurement cell is half filled with test sample and a measurement conducted and recorded, the measurement cell is then filled with test sample and a second measurement conducted. In one embodiment, Measurement 2 is approximately half the reading of Measurement 1. If Measurement 2 is much less than half of Measurement 1, reagent is the limiting reactant and more reagent is required in the following measurement sequence. If Measurement 2 is greater than half of Measurement 1, reagent is in excess and less reagent can be used in the following measurement sequence. If Measurement 2 is approximately half of Measurement 1, then the amount of reagent being used is optimal.

In an alternative embodiment, reagent use is optimized to conserve reagent while still ensuring that an excess of reagent is provided relative to the hydrogen peroxide concentration. At least two readings are obtained from one sample and used to determine reagent requirement. The control system sets the reagent dose for the subsequent test sample based on measurements obtained from a previous test sample. The steps are as follows:
Measurement cell 15 is filled with sample water;
Measurement cell 15 is emptied, flushing measurement cell 15 to keep it clean;
Measurement cell 15 is refilled with sample water;
Perform a zero measurement (null value);
Measurement cell 15 is emptied;
Measurement cell 15 is refilled but at the beginning of the fill cycle, a timed addition of reagent from vial 40 is added to the sample;
The measurement cell is filled halfway;
Measurement 1 is conducted;
The measurement cell is filled fully with sample water without the addition of extra reagent;
Measurement 2 is conducted;
Comparison of Measurement 1 value and Measurement 2 value. This step is necessary to determine if the amount of reagent is sufficient in relation to the measured hydrogen peroxide value. Measurement 2 is about half the reading of Measurement 1. Empty measurement cell 15;
Rinse measurement cell 15 with sample water;
Fill and keep measurement cell 15 full until the next measurement is required.

The complete sequence in one embodiment takes about 2 minutes. The smallest wait time between two sequences is about 10 seconds. Multiple apparatuses may be added in the same location with offset measurement times to provide continuous accurate measurements of hydrogen peroxide concentrations in that area over time.

When developing the reagent for use with colorimetric apparatus 400, consideration was taken for various degrees of water hardness and the presence of trace metals. The reagent can be used to measure the hydrogen peroxide content in water samples having a wide range of pH, temperature and water hardness.

The control unit 35 may also include a control system 300 functionality having a H₂O₂ dosing and control algorithm that compares the measured H₂O₂ concentration to a set point that defines the desired concentration of H₂O₂ in the water treatment and distribution system from which the apparatus is diverting water to the colorimetric apparatus 400 for measurement. The set point may be defined as a discrete value such as 8 ppm or as a range such as between 2-10 ppm. A set point can be used to define the established standard or the established threshold. The control system 300 is further configured to control a H₂O₂ dosing apparatus 225 of the water treatment and distribution system in response to the measured H₂O₂ concentration and the set point. The dosing apparatus 225 is located upstream of the colorimetric apparatus 400 such that additions of H₂O₂ made by the dosing apparatus are monitored by the colorimetric apparatus 400 and subsequent measurements are re-evaluated by the dosing algorithm relative to the set point. A water treatment and distribution system may have multiple colorimetric apparatus 400 for measurement and multiple control units 35, and one or more control system 300 apparatus, distributed throughout the treatment and distribution system. Alternatively, one control system 300 may obtain input from multiple measurement colorimetric apparatus 400 (control unit 35) and control multiple dosing apparatus 225.

An exemplary dosing and control algorithm is a Proportional-Integral-Derivative (PID) control algorithm. A PID control is a common control algorithm used in industry and has been universally accepted in industrial control. PID controllers have robust performance in a wide range of operating conditions and their functional simplicity allows for ease of operation.

Under a PID control, or other such control algorithm, the control system 300 can be configured to direct the actions of the dosing apparatus 225 to provide an effective amount of SHP and thereby maintain a desired

### Example 1

A regional water treatment and distribution system was modified to evaluate the performance of SHP as a method of secondary disinfection as an alternative to chlorine-based potable water disinfection.

The SHP used was Huwa-San Peroxide (HSP). Water samples were taken before the introduction of HSP to establish baseline levels of water quality indicators such as, for example, chlorination disinfection by-products and microbial content.

Over a first 31-day period, just after changeover from a chlorine-based secondary disinfectant to a stabilized hydrogen peroxide-based secondary disinfectant, minimum hydrogen peroxide residuals were measured every day at each monitoring apparatus 250a, 250b, 250c. An average of about 12 ppm was measured at monitoring apparatus 250a, an average of about 9 ppm was measured at monitoring apparatus 250b an average of about 6 ppm was measured at monitoring apparatus 250c.

As the peroxide demand dropped through the remediation of low level biofilm in distribution, less hydrogen peroxide dosing was required. Eight months later, over a 31-day period, at the same locations, an average of about 6 ppm was measured at monitoring apparatus 250a, an average of about 6 ppm was measured at monitoring apparatus 250b an average of about 5 ppm was measured at monitoring apparatus 250c. The readings at monitoring apparatus 250c, which was located in the distribution network, ranged from about 4 ppm to about 6 ppm which was within the accepted standard. In addition, the smaller drop in consumed hydrogen peroxide between adjacent monitoring apparatus confirmed that less hydrogen peroxide was being oxidized in the water treatment system and by the first connection point of the distribution system.

In comparison with the THM levels described in the system of FIG. 1, since the system of FIG. 2 was started, monthly levels of THMs ranged from 21-26 μg/L with an average of 24 μg/L. The replacement of chlorine with SHP as a secondary disinfectant in the system resulted in a drastic reduction in THMs. For example, THM concentrations were lowered by up to 75% compared to those generated using sodium hypochlorite in the secondary treatment stage.

In addition to THMs, all other measured test parameters were within acceptable levels, including lead, copper, pH, ATP (biofilm), heterotrophic plate count, legionella pneumophila. It was observed that microbial equivalents (#/mL) were higher in raw water than in the treated water leaving the treatment system and within the distribution line. This indicated the suppressive capacity of HSP.

### Example 2

The objective of this example was to verify the accuracy of one embodiment of the present invention, in the lowest range of 1-5 ppm by testing samples having a known concentration of H₂O₂ in the range of 1-5 ppm.

The sample was prepared as follows: A 350 mg/L standard solution of hydrogen peroxide was prepared with 2 mL of 30% aqueous solution H₂O₂ (Perhydrol™), which was pipetted into a 2,000 ml volumetric flask. The solution was then topped with distilled water.

The exact concentration of this solution was determined analytically by multiple iodometric titrations (see Table 2, below). The average result of these titrations was taken to be the true concentration of the prepared solution of H₂O₂.

TABLE 2

| | Volume of sodium | Corresponding |
|---|---|---|
| | thiosulphate used in titration | concentration of |
| | (mL) | H₂O₂ (mg/L) |
| Titration 1 | 10.45 | 355 |
| Titration 2 | 10.10 | 344 |
| Titration 3 | 10.55 | 359 |

The final concentration of the H₂O₂ standard was calculated to be:

$$[ {H}_{2} {O}_{2} ] = \overline{X} = \frac{355 + 344 + 359}{3} = 353 \frac{mg}{l}$$

From the standard solution (350 mg/L H₂O₂) five dilutions were prepared with a final concentration of 5, 4, 3, 2 and 1 mg/L H₂O₂. The quantities were pipetted from the H₂O₂ standard solution into 100 mL volumetric flasks to achieve these concentrations are shown below in Table 3.

TABLE 3

| Target concentration | Volume pipetted from standard solution |
|---|---|
| (mg/L) | (ml) |
| 5 | 1.42 |
| 4 | 1.13 |
| 3 | 0.85 |
| 2 | 0.57 |
| 1 | 0.283 |

The apparatus of one embodiment of the present invention was then used to independently determine the concentrations in the above solutions of H₂O₂. Three measurement runs were taken for each sample. The results of the apparatus measurements and average values are presented in Table 4.

TABLE 4

| Predicted conc. | Measured Values of | | | Average of measured |
|---|---|---|---|---|
| H₂O₂ | Apparatus (mg/L) | | | results (mg/L) with |
| (mg/L) | Run 1 | Run 2 | Run 3 | margin of error |
| 1.0 | 0.9 | 1.1 | 1.0 | 1.0 ± 0.1 |
| 2.0 | 2.0 | 2.1 | 2.0 | 2.0 ± 0.1 |
| 3.0 | 2.9 | 3.0 | 3.1 | 3.0 ± 0.1 |
| 4.0 | 4.0 | 3.9 | 4.0 | 4.0 ± 0.1 |
| 5.0 | 5.0 | 5.1 | 5.0 | 5.0 ± 0.1 |

The discrepancy between the predicted and measured values was assumed to be solely due to inaccuracies in the apparatus' ability to measure concentrations of H₂O₂. The values of the samples of H₂O₂ in solution measured by the apparatus in one embodiment of the present invention are linear. The apparatus itself is able to measure the concentration of H₂O₂ in solution with a degree of accuracy of 0.1 mg/L in the range of 1-5 mg/L H₂O₂.

### Example 3

A standard curve was generated and digitized data on the X-axis (vertical) plotted relative to hydrogen peroxide concentration on the Y-axis (horizontal). Table 5 presents data for two known concentrations (Points A, B) of H₂O₂ and one unknown concentration (Point C).

TABLE 5

| Point | Measured value (X) | Concentration (Y) (ppm) |
|---|---|---|
| A | 208 | 21.4 |
| B | 92 | 42.23 |
| C | 142 | To be determined |

An equation to represent the line between two known points is determined. The known points are selected based on proximity to that of the unknown measurement such that the unknown lies between the two known points. In this case, for the selected known data points, the difference in X values (delta X) and the difference in Y values (delta Y) is calculated by:

Delta X=Xa−Xb=208−92=116

Delta Y=Ya−Yb=21.4−42.23=−20.83

Slope=dY/dX=−20.83/116=−0.18
Yc is the unknown H₂O₂ concentration represented by the coordinate Yc.
Distance Xc:b from a known data point is calculated;

Xc−Xb=142−92=50 Yc=(Xc−Xb)*slope+Yb=(142−92)*−0.18+42.23=33.23
The unknown Yc can alternatively be calculated from point B (Xc−Xa)

Yc=(Xc−Xa)*slope+Ya=(142−208)*−0.18+21.4=33.28

While the invention has been described with respect to a specific apparatus and method for measuring hydrogen peroxide in water, and controlling the level of hydrogen peroxide in water, it may equally be applied to other apparatuses having various structures, so long as they include the elements as described herein.

1. A water treatment and distribution system comprising:
a. a primary disinfectant apparatus for disinfecting source water;
b. a first dosing apparatus to inject stabilized hydrogen peroxide into the system;
c. a first monitoring apparatus to measure the concentration of hydrogen peroxide residual;
d. one or more further monitoring apparatus to measure the concentration of hydrogen peroxide residual downstream of the first monitoring apparatus;
e. one or more further dosing apparatus proximate the one or more further monitoring apparatus, each capable of injecting stabilized hydrogen peroxide into the system; and
f. a network of pipes connecting the source water to the primary disinfectant apparatus, the primary disinfectant apparatus to the first dosing apparatus, the first dosing apparatus to the first monitoring apparatus, the first monitoring apparatus to the one or more further monitoring apparatus and the one or more further monitoring apparatus to the one or more further dosing apparatus;
wherein each monitoring apparatus is configured to provide an accuracy of 0.1 mg/L hydrogen peroxide.

2. The system of claim 1, wherein the first monitoring apparatus and the one or more further monitoring apparatus measure the residual and transmit measured residual data to a control system and the first dosing apparatus and the one or more further dosing apparatus receive signals from the control system to dose stabilized hydrogen peroxide.

3. The system of claim 2, wherein the control system monitors changes in measured residual data from two or more monitoring apparatus and compares the change to an established standard and the control system transmits signals to dose an effective amount of stabilized hydrogen peroxide to the one or more further dosing apparatus if a measured residual data has reached an established threshold.

4. The system of claim 1, wherein at least one of the one or more further monitoring apparatus is located at a first or subsequent connection in the distribution system and at least one of the one or more further dosing apparatus is located at a first or subsequent connection in the distribution system.

5. A method of maintaining water integrity in a water treatment and a distribution system, comprising:
a. disinfecting source water with a primary disinfectant;
b. injecting stabilized hydrogen peroxide to the water;
c. making a first measurement of the residual stabilized hydrogen peroxide in the water accurate to 0.1 mg/L;
d. downstream, making a second measurement of the residual stabilized hydrogen peroxide in the water accurate to 0.1 mg/L;
e. making a first determination whether the difference in the first and second measurements is within an established standard; and
f. injecting an effective amount of stabilized hydrogen peroxide in the water if the difference is not within the established standard.

6. The method of claim 5 further comprising:
a. Downstream of the first measurement, making one or more subsequent measurements of the residual stabilized hydrogen peroxide in the water accurate to 0.1 mg/L;
b. making a further determination whether the difference in two preceding measurements is within the established standard; and
c. injecting an effective amount of stabilized hydrogen peroxide in the water if the difference in the two preceding measurements is not within the established standard.

7. A monitoring apparatus for measuring hydrogen peroxide in water using a colorimetric assay method comprising:
a. a measurement cell for containing a water sample;
b. a light transmitter configured to emit light at a selected wavelength at the measurement cell;
c. a photodiode receiver configured to receive light passing through the measurement cell;
d. a reagent in a reagent vial, consisting of:
i. a reagent compound configured to react with hydrogen peroxide to form a reaction product, the reaction product adapted to absorb light at the selected wavelength proportional to the amount of hydrogen peroxide in the water sample,
ii. a surfactant, and
iii. a solvent; and
e. a first network of pipes connecting the source water to a buffer jar, the buffer jar to a supply valve, the supply valve to the measurement cell, and a second network of pipes connecting the reagent vial to a reagent valve, the reagent valve to the measurement cell, and the measurement cell to a drain valve;
f. a control unit;
wherein the control unit is configured to cause a first colorimetric measurement of a first water sample free of reagent and a second colorimetric measurement of a second water sample mixed with reagent, then determines the difference between the first and second measurements and compares the difference against a pre-determined standard curve of diluted hydrogen peroxide to determine and report the concentration of hydrogen peroxide in the water sample, accurate to 0.1 mg/L.

8. The monitoring apparatus of claim 7 where in the reagent compound is potassium bis (oxalato) oxotitanate (IV) DI; the selected wavelength is 470 nm; the light transmitter is a LED light emitter; the reagent further comprises EDTA di-sodium salt dehydrate; the surfactant is polyoxyethylene (23) lauryl ether; and the solvent is sulfuric acid 99%: p.a. 10% solution.

9. The monitoring apparatus of claim 7, wherein the predetermined standard curve comprises data points from 0 ppm to 150 ppm.

10. The monitoring apparatus of claim 7, wherein the predetermined standard curve comprises data points from 0 ppm to 100 ppm.

11. A method of for measuring hydrogen peroxide levels in water using a colorimetric assay method comprising:
a. transferring a first water sample to a measuring cell;
b. determining a first absorbance measurement of light at a selected wavelength as a null measurement;
c. removing the first sample from the measurement cell;
d. transferring an aliquot of a reagent consisting of a reagent compound configured to react with hydrogen peroxide, reacts to form a reaction product, the reaction product adapted to absorb light at the selected wavelength proportional to the amount of hydrogen peroxide in the water sample to the measurement cell;
e. filling the measurement cell with a second water sample;
f. determining a second absorbance measurement of light at the selected wavelength as a test measurement;
g. emptying the measurement cell and rinsing with sample water; and
h. a control unit adapted to determine the difference between the first and second measurements and compare the difference against a pre-determined standard curve of diluted hydrogen peroxide to determine and report the concentration of hydrogen peroxide in the water sample to an accuracy of 0.1 mg/L.

12. The method of claim 11, wherein the reagent compound is potassium bis (oxalato) oxotitanate (IV) DI; the selected wavelength is 470 nm; the light transmitter is a LED light emitter; the reagent further comprises EDTA di-sodium salt dehydrate; the surfactant is polyoxyethylene (23) lauryl ether; and the solvent is sulfuric acid 99%: p.a. 10% solution.

13. The method of claim 11, wherein the predetermined standard curve comprises data points from 0 mg/L to 150 mg/L.

14. The method of claim 11, wherein the predetermined standard curve comprises data points from 0 mg/L to 100 mg/L.
